(19) United States
(12) Patent Application Publication
(10) Pub. No.: US 2014/0245989 A1
(43) Pub. Date: Sep. 4, 2014

(54) GASEOUS STATE MOLECULAR COMBUSTION-SUPPORTING DEVICE

(71) Applicant: Kao-Shan LIN, Taipei (TW)

(72) Inventor: Kao-Shan LIN, Taipei (TW)

(21) Appl. No.: 13/783,627

(22) Filed: Mar. 4, 2013

(51) Int. Cl. F02M 25/028

(52) U.S. Cl. CPC F02M 25/028
USPC 123/25 A

(57) ABSTRACT

A gaseous state molecular combustion-supporting device includes a first bottle for accommodating liquid. The first bottle is provided with an intake pipe and a connecting pipe that is connected with a second bottle received therein with gas-liquid separating filter materials and disposed with an exhaust pipe, which is connected with an intake manifold of an engine. When gaseous state molecule produced via the gas-liquid separating filter materials passes through the exhaust pipe and gets into an engine to be mixed with the fuel oil to carry out combustion, hydrogen and oxygen decomposed out of the gaseous state molecule help attain an efficacy of perfect combustion, able to lessen exhaust emission, reduce carbon deposition in the engine, enable the engine to operate smoothly and lower the temperature of the whole engine.

### BACKGROUND OF THE INVENTION

1. Field of the Invention

This invention relates to a gaseous state molecular combustion-supporting device.

2. Description of the Prior Art

In an operating process, a common engine is driven to operate by detonating combustion of the fuel oil in a cylinder, but the detonating combustion of air and fuel oil are often incomplete and hence it is likely to produce much waste gas and cause carbon deposition in the engine, under high temperature, a proper amount of water molecule can be decomposed to produce hydrogen and oxygen to attain a combustion-supporting effect, able to achieve perfect combustion, lower exhaust emission and eliminate deposited carbon in the engine.

A first conventional water combustion apparatus, as shown in FIG. 1, includes a bottle 1 for accommodating water or a mixed solution of water and ethyl alcohol. The bottle 1 is provided with an air intake pipe 2 inserted in the bottle 1 and having an exhaust end positioned in the liquid of the bottle 1. Further, the bottle 1 has an upper end disposed with an exhaust pipe 3 having an intake end located over the surface of the liquid in the bottle 1 and an exhaust end connected to an intake manifold 300 of an engine 200. in view of the situation that when the engine 200 is operated, the intake manifold 300 will produce negative pressure by which air will be guided into the engine 200 to be mixed with fuel oil for detonating combustion; therefore, in the operating process of the engine 200, the negative pressure produced by the intake manifold 300 will also make the bottle 1 to produce negative pressure therein to have the air intake pipe 2 suck in air. And, when the air passes through the liquid in the bottle 1, there will produce bubbles for increasing the amount of dissolved oxygen in the liquid, and the bubbles will burst on the surface of the liquid to form small liquid drops containing oxygen to be sucked and guided into the engine 200 via the negative pressure produced by the intake manifold 300.

The small liquid drops are able to absorb latent heat and vaporize under high temperature in the engine 200 so the temperature in the process of detonating combustion of fuel oil can be effectively lowered. However, although having function to lower the temperature of the engine 200, yet the small liquid drops with high water content will cause excessive water vapor to be led into the engine 200 and hence result in detonation to the engine 200 and affect detonating combustion of the fuel oil and even worse, cause rust, corrosion and damage to the engine 200.

A second conventional water combustion apparatus, as shown in FIG. 2, includes a bottle 4 for accommodating water or a mixed solution of water and ethyl alcohol. The bottle 4 is installed therein with an atomizer 5 for atomizing the liquid in the bottle 4 to form water molecule. The bottle 4 has an upper end provided with a connecting pipe 6 having an intake end positioned over the surface of the liquid in the bottle 4 and an exhaust end inserted in an atomized water-collecting bottle 7, which has an upper end disposed with an exhaust pipe 8 connected with an intake manifold 300 of an engine 200.

When the engine 200 is operated, the negative pressure produced by the intake manifold 300 will make the atomized water-collecting bottle 7 also produce negative pressure in the interior and thus, after being atomized by the atomizer 5, the water molecule produced can be sucked and guided into the atomized water-collecting bottle 7 by means of the negative pressure and then guided into the engine 200 to lower the temperature of the engine 200. Although the water molecule with excessive water content can be condensed into water drops in the atomized water-collecting bottle 7 and stagnated therein when the water molecule with excessive water content passes through the atomized water-collecting bottle 7, yet the mechanism of making the water molecule with excessive water content condensed into water drops is imperfect and the effect is limited and as a result, water vapor guided into the engine 200 is still too much and the engine 200 can hardly to operate smoothly.

### SUMMARY OF THE INVENTION

The objective of this invention is to offer a gaseous state molecular combustion-supporting device, which is able to filtrate and separate water vapor that contains too much water content to produce gaseous state molecule to be guided into an engine for attaining an object of complete combustion to enable the engine to operate more smoothly.

The gaseous state molecular combustion-supporting device in the present invention includes a first bottle for accommodating liquid. The first bottle is provided with an intake pipe inserted in the first bottle and having two ends respectively defined to be an intake end and an exhaust end. The first bottle is further disposed with a connecting pipe whose ends are respectively defined to be an intake end and an exhaust end, and the intake end of the connecting pipe is inserted into an upper end of the first bottle while the exhaust end is inserted into a second bottle, which is employed for accommodating plural gas-liquid separating filter materials and provided with an exhaust pipe.

The exhaust pipe of the gaseous state molecular combustion-supporting device is further connected with an intake manifold that is connected with an engine. The gas-liquid separating filter materials in the second bottle function to filtrate and separate water vapor that contains excessive water content and produce gaseous state molecule to be guided into the engine through the exhaust pipe. When the gaseous state molecule is mixed with the fuel oil in the engine to carry out detonation combustion, the gaseous state molecule will be decomposed to produce hydrogen and oxygen to support combustion, thus attaining efficacy of complete combustion, enabling the engine to operate smoothly and lowering the temperature of the whole engine.

### BRIEF DESCRIPTION OF DRAWINGS

This invention will be better understood by referring to the accompanying drawings, wherein:

FIG. 1 is a schematic view of a first conventional water combustion apparatus;

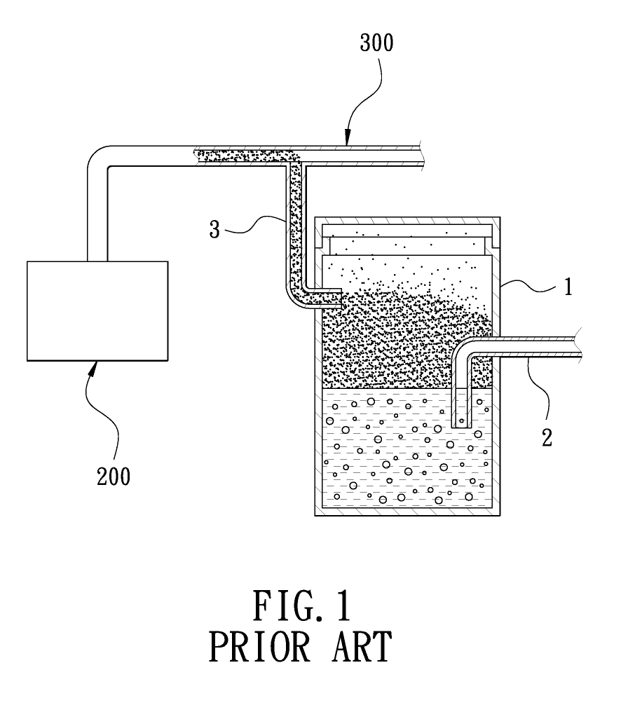

FIG. 2 is a schematic view of a second conventional water combustion apparatus;

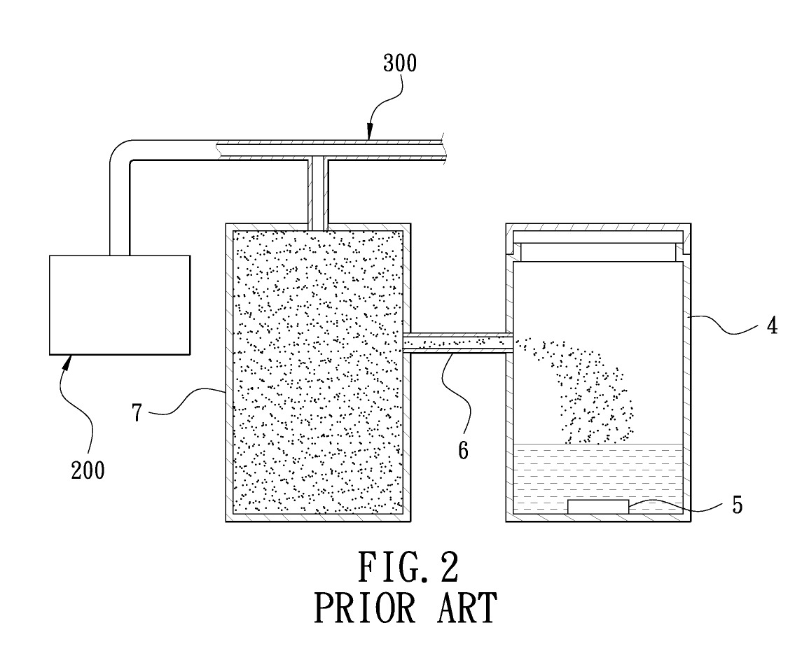

FIG. 3 is a perspective view of a first preferred embodiment of a gaseous state molecule combustion-supporting device in the present invention;

FIG. 4 is a cross-sectional view of the first preferred embodiment of a gaseous state molecule combustion-supporting device in the present invention;

FIG. 5 is a cross-sectional view of the first preferred embodiment of a gaseous state molecule combustion-supporting device in the present invention, illustrating that water vapor in a first bottle is sucked into a second bottle via a connecting pipe;

FIG. 6 is a cross-sectional view of a second preferred embodiment of a gaseous state molecule combustion-supporting device in the present invention; and

FIG. 7 is a cross-sectional view of a third preferred embodiment of a gaseous state molecule combustion-supporting device in the present invention.

### DETAILED DESCRIPTION OF THE PREFERRED EMBODIMENT

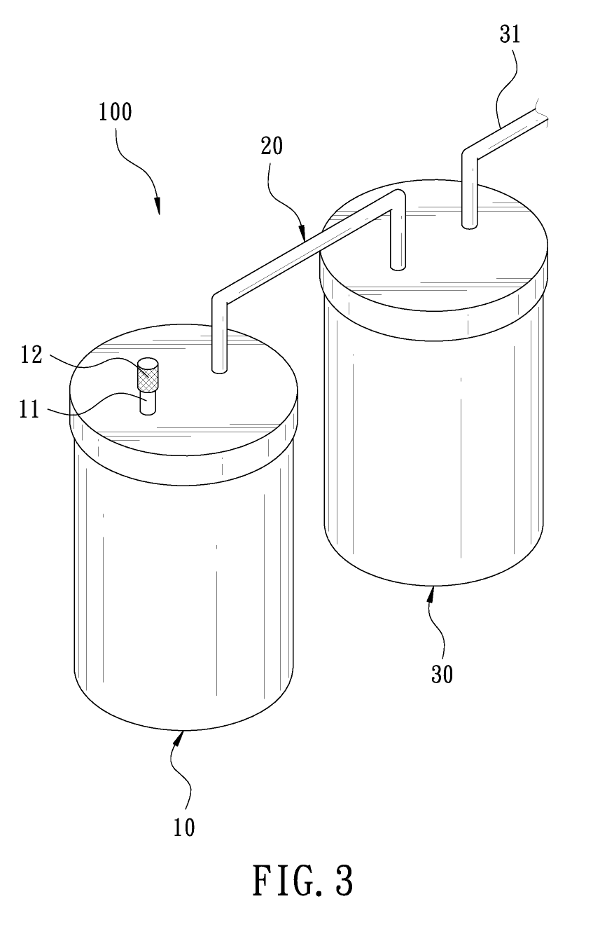

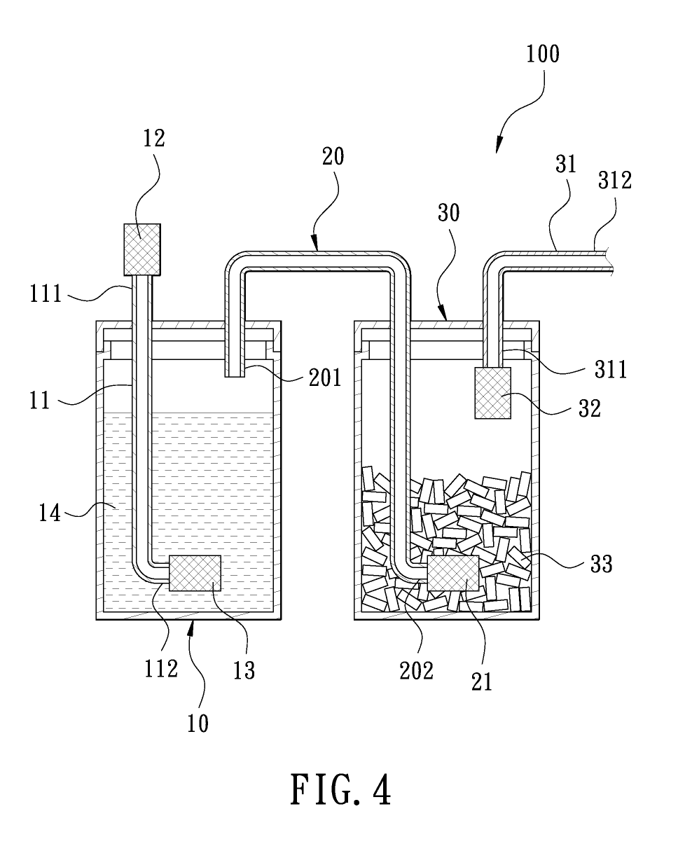

A first preferred embodiment of a gaseous state molecular combustion-supporting device 100 in the present invention, as shown in FIGS. 3 and 4, includes a first bottle 10, a connecting pipe 20 and a second bottle 30 as main components combined together.

The first bottle 10 is employed for accommodating liquid 14. In this preferred embodiment, the liquid 14 is water, but this is merely a preferred embodiment of this invention and actually, ethyl alcohol or a mixed solution of ethyl alcohol and water can be chosen to be the liquid 14, for ethyl alcohol with low ignition point and high volatility can similarly attain a combustion-supporting effect. The first bottle 10 is provided with an air intake pipe 11 inserted in the first bottle 10 and having both ends respectively defined to be an intake end 111 and an exhaust end 112. The intake end 111 of the air intake pipe 11 is located at an outer side of the first bottle 10 to communicate with the outside of the bottle 10 and provided thereon with a first filter material 12, which is an air filter in this preferred embodiment, for filtrating particles in air. The exhaust end 112 of the air intake pipe 11 is disposed thereon with a first air stone 13 and fixed inside the first bottle 10, extending downward to the lower end of the first bottle 10 and located in the liquid 14. Thus, air can go out of the liquid 14 in the first bottle 10 and produce minute bubbles via the porous first air stone 13.

The connecting pipe 20 has two ends respectively defined to be an intake end 201 and an exhaust end 202. The intake end 201 of the connecting pipe 20 is positioned at an inner upper end of the first bottle 10 while the exhaust end 202 is provided with a second air stone 21.

The second bottle 30 accommodates a plurality of gas-liquid separating filter materials 33. In this preferred embodiment, the gas-liquid separating filter materials 33 are a plurality of spongy blocks formed with gaps, but this is merely a preferred embodiment of this invention and substantially, a material whose specific gravity is less than water or ethyl alcohol or other liquid with a same effect and which is heavier than air can be chosen to be the gas-liquid separating filter material 33, such as a plurality of poly-foam blocks or plural PU blocks. The exhaust end 202 of the connecting pipe 20 is inserted in the second bottle 30, extending downward to the lower end of the second bottle 30. The second bottle 30 is further provided with an exhaust pipe 31 having two ends respectively defined to be an intake end 311 and an exhaust end 312. The intake end 311 of the exhaust pipe 31 is positioned over the gas-liquid separating filter material 33 and provided thereon with a second filter material 32, which is an air filter in this preferred embodiment, while the exhaust end 312 of the exhaust pipe 31 is located out of the second bottle 30.

The exhaust pipe 31 is connected with an intake manifold that is connected with an engine to enable the gaseous state molecular combustion-supporting device 100 to communicate with the engine.

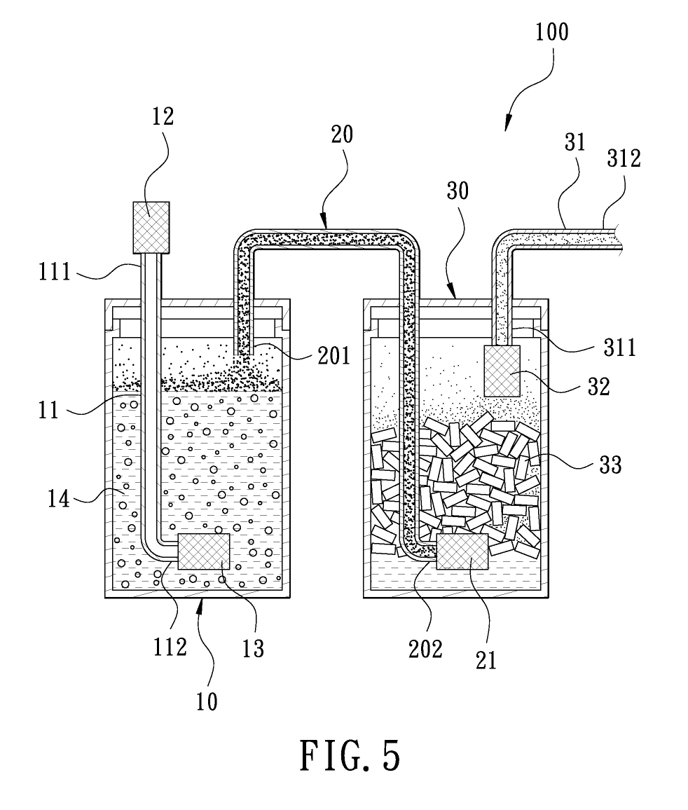

Referring to FIG. 5, when the engine is operated, the negative pressure produced by the intake manifold will make the second bottle 30 produce negative pressure in the interior, too, and simultaneously, the interior of the first bottle 10 will also form negative pressure to enable the intake pipe 11 to suck in air.

The bubbles produced when the first air stone 13 gives out air will enhance a mutual contact area of the air with the liquid 14 when the air passes through the liquid 14 to increase the amount of dissolved oxygen in the liquid 14 and then, the bubbles will burst on the surface of the liquid 14 to form water vapor containing oxygen to be sucked into the second bottle 30 via the connecting pipe 20.

The gaps of the gas-liquid separating filter materials 33 in the second bottle 30 function to suck the water vapor that contains excessive water content to let the water vapor condensed on the gas-liquid separating filter materials 33, only letting gaseous state molecule containing oxygen pass through between the gaps, attaining the object of filtrating and separating the water vapor that contains too much water content. Thus, the water molecule passing through the exhaust pipe 31 of the second bottle 30 is gaseous state molecule containing oxygen. After getting into the engine, the gaseous state molecule will be mixed with the fuel oil to carry out detonating combustion and in the meantime, the gaseous state molecule containing oxygen will further produce hydrogen under high temperature, and the hydrogen and the oxygen decomposed out of the gaseous state molecule can attain combustion-supporting effect for carrying out perfect combustion in the engine, able to lower exhaust emission, reduce carbon deposition and enable the engine to operate smoothly.

One thing worth mentioning is that before being decomposed to produce hydrogen and oxygen under high temperature in the engine, the gaseous state molecule will absorb latent heat so the temperature of the whole engine can be lowered effectively.

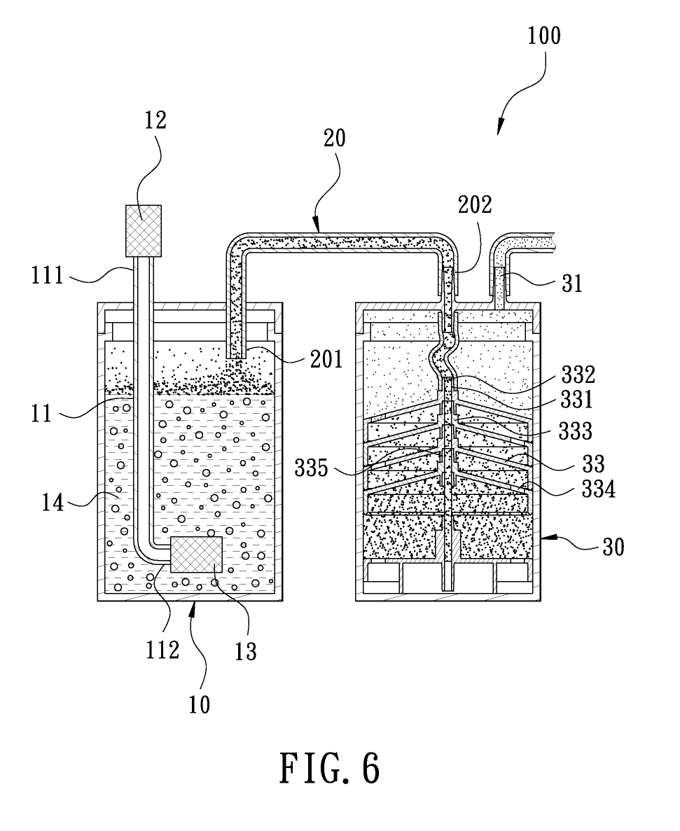

A second preferred embodiment of a gaseous state molecule combustion-supporting device 100 in the present invention, as shown in FIG. 6, has almost the same structure as that described in the first preferred embodiment, except that the gas-liquid separating filter materials 33 received in the second bottle 30 are plural boards respectively bored with a plurality of through holes, and the gas-liquid separating filter materials 33 respectively slant outward and downward from the center to let the gas-liquid separating filter materials 33 formed with a convex arc surface. The gas-liquid separating filter materials 33 has a central portion fixed with a post 331 extending upward and bored with a lengthwise insert hole 332 axially passing through the post 331. The post 331 has an outer circumferential wall provided thereon with a radial positioning plate 333, and the gas-liquid separating filter materials 33 have their undersides respectively formed with a recess 335 at mutually corresponding locations for facilitating the gas-liquid separating filter materials 33 to be piled and engaged with each other to make the gas-liquid separating filter materials 33 form a multi-ply structure. Further, the gas-liquid separating filter materials 33 are respectively bored with a plurality of through holes 334. Nevertheless, this is merely a preferred embodiment in the present invention and substantially, poly-foam boards or PU boards, which are respectively formed with plural through holes, can also be chosen to be the gas-liquid separating filter materials 33. Furthermore, the exhaust end 202 of the connecting pipe 20 communicates with the lengthwise insert hole 332 of the post 331 and also connected to the lower end of the second bottle 30 via the insert hole 332.

It should be emphasized that one special feature of the second preferred embodiment is that the through holes 334 of every two adjacent gas-liquid separating filter materials 33 are staggered in arrangement for enhancing the efficacy of gas-liquid separation, and additionally, the number of the through holes 334 of the gas-liquid separating filter materials 33 are gradually reduced layer by layer from the lowermost layer to the uppermost layer so as to further elevate the effect of gas-liquid separation.

When water vapor in the first bottle 10 is sucked into the second bottle 30, the gas-liquid separating filter materials 33 received in the second bottle 30 are able to absorb the water vapor that contains too much water content and have the water vapor condensed and attached to the gas-liquid separating filter materials 33 when the water vapor circuitously passes through the through holes 334 of the gas-liquid separating filter materials 33, able to attain the object of filtrating and separating the water vapor that contains excessive water content. Thus, the water molecule passing through the exhaust pipe 31 of the second bottle 30 is gaseous state molecule containing oxygen, able to attain a combustion-supporting effect. By so designing, combustion in the engine becomes more perfect and hence carbon deposition in the engine can be reduced and even eliminated to enable the engine to operate more smoothly.

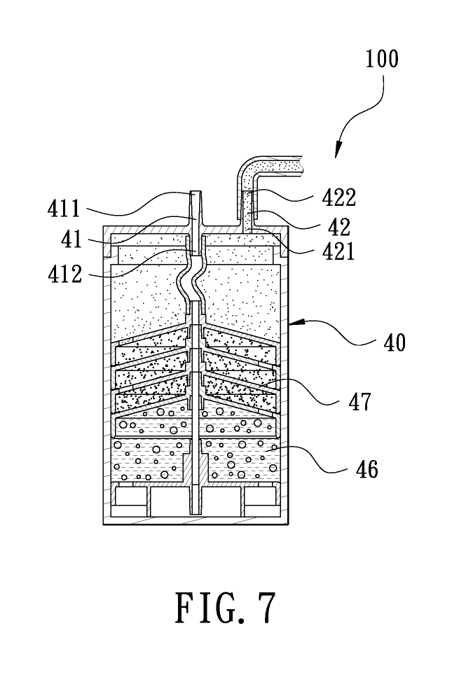

A third preferred embodiment of a gaseous state molecular combustion-supporting device 100 in the present invention, as shown in FIG. 7, includes a bottle for accommodating liquid 46. In this preferred embodiment, the liquid 46 is water, but this is merely a preferred embodiment not confined to the mode of this invention. The bottle 40 is provided with an intake pipe 41 inserted in the bottle 40 and having two ends respectively defined to be an intake end 411 and an exhaust end 412. The intake end 411 is located at an outer side of the bottle 40 to communicate with the outside of the bottle 40, while the exhaust end 412 is able to be connected to the liquid 46. In addition, a plurality of gas-liquid separating filter materials 47 are received in the bottle 40 and positioned on the liquid 46. In this preferred embodiment, the gas-liquid separating filter materials 47 are plural boards, which are the same in structure and special feature as those described in the second preferred embodiment and needless to be stated any more, but this is merely a preferred embodiment of this invention and actually, a material, which is less than water or other liquid with same efficacy in specific gravity and which is heavier than air, can be chosen to be the gas-liquid separating filter materials 47. The bottle 40 has an upper end provided with an exhaust pipe 42 having two ends respectively defined to be an intake end 421 and an exhaust end 422.

The exhaust pipe 42 is connected with an intake manifold that is connected to an engine so that the gaseous state molecular combustion-supporting device 100 can communicate with the engine.

Referring to FIG. 7, the gas-liquid separating filter materials 47 floating on the liquid 46 are able to absorb water vapor that contains too much water content separating filter materials 47, only permitting gaseous and have the water vapor condensed on the gas-liquid state molecule containing oxygen to pass through the through holes 334 of the gas-liquid separating filter materials 33, attaining the object of filtering and separating water vapor that contains excessive water content. Thus, the water molecule passing through the exhaust pipe 42 of the bottle 40 is gaseous state molecule containing oxygen. The gaseous state molecular combustion-supporting device 100 in the third preferred embodiment not only has the same efficacy and advantages as those described in the previous preferred embodiments, but also can diminish the volume of the gaseous state molecular combustion-supporting device 100 to enable the gaseous state molecular combustion-support device 100 to be employed in a small space.

While the preferred embodiments of the invention have been described above, it will be recognized and understood that various modifications may be made therein and the appended claims are intended to cover all such modifications that may fall within the spirit and scope of the invention.

What is claims is:

1. A gaseous state molecular combustion-supporting device comprising:
a bottle for accommodating liquid, said bottle provided with an intake pipe, said intake pipe inserted in said bottle, said intake pipe having two ends respectively defined to be an intake end and an exhaust end, said intake end located at an outer side of said bottle to communicate with outside of said bottle, said exhaust end positioned in said liquid, a plurality of gas-liquid separating filter materials received in said bottle and positioned on said liquid, said bottle having an upper end provided with an exhaust pipe, said exhaust pipe having two ends respectively defined to be an intake end and an exhaust end, said intake end of said exhaust pipe located over said gas-liquid separating filter materials, said exhaust end of said exhaust pipe positioned at an outer side of said bottle for connecting an intake manifold of an engine.

2. The gaseous state molecular combustion-supporting device as claimed in claim 1, wherein said intake end of intake pipe is provided with a first filter material, and said intake end of said exhaust pipe is provided with a second filter material.

3. The gaseous state molecular combustion-supporting device as claimed in claim 1, wherein said exhaust end of said intake pipe is set with an air stone.

4. A gaseous state molecular combustion-supporting device comprising:
a first bottle for accommodating liquid, said first bottle formed with an intake pipe, said intake pipe inserted in said first bottle, said intake pipe having two ends respectively defined to be an intake end and an exhaust end, said intake end of said intake pipe located at an outside of said first bottle to communicate with the outside of said first bottle, said exhaust end of said intake pipe positioned in said liquid;
a connecting pipe having two ends respectively defined to be an intake end and an exhaust end, said intake end of said connecting pipe provided at an upper end of said first bottle and positioned over said liquid; and
a second bottle used for accommodating plural gas-liquid separating filter materials, said exhaust end of said connecting pipe inserted in said second bottle, said second bottle having an upper end disposed with an exhaust pipe, said exhaust pipe having two ends respectively defined to be an intake end and an exhaust end, said intake end of said exhaust pipe located over said gas-liquid separating filter materials, said exhaust end of said exhaust pipe positioned out of said second bottle to be connected with an intake manifold that is connected to an engine.

5. The gaseous state molecular combustion-supporting device as claimed in claim 4, wherein said intake end of said intake pipe is provided with a first filter material while said intake end of said exhaust pipe is set thereon with a second filter material.

6. The gaseous state molecular combustion-supporting device as claimed in claim 4, wherein said exhaust end of said intake pipe is provided with a first air stone while said exhaust end of said connecting pipe is provided with a second air stone.

7. The gaseous state molecular combustion-supporting device as claimed in claim 4, wherein said liquid is water.

8. The gaseous state molecular combustion-supporting device as claimed in claim 4, wherein said gas-liquid separating filter materials are plural spongy blocks formed with gaps.

9. The gaseous state molecular combustion-supporting device as claimed in claim 1, wherein said gas-liquid separating filter materials are plural boards, and said gas-liquid separating filter materials respectively slant outward and downward form a center to make said gas-liquid separating filter materials form a convex arc surface, said gas-liquid separating filter materials having a central portion provided with a post extending upward, said post bored with an insert hole, said insert hole axially passing through said post, said post having an outer circumferential wall fixed thereon with a radial positioning plate and said gas-liquid separating filter materials having their undersides respectively disposed with a recess at mutually corresponding locations for said gas-liquid separating filter materials to be piled and engaged with each other, making said gas-liquid separating filter materials form a multi-ply structure, said gas-liquid separating filter materials respectively bored with a plurality of through holes, said through holes of every two adjacent said gas-liquid separating filter materials staggered in arrangement, the number of said through holes of said gas-liquid separating filter materials gradually decreased layer by layer from the lowermost layer to the uppermost layer, said exhaust end of said intake pipe communicating with said insert hole of said post.

10. The gaseous state molecular combustion-supporting device as claimed in claim 4, wherein said gas-liquid separating filter materials are plural boards, and said gas-liquid separating filter materials respectively slant outward and downward from a center to make said gas-liquid separating filter materials form a convex arc surface, said gas-liquid separating filter materials having a central portion fixed with a post extending upward, said post bored with an insert hole, said insert through hole axially passing through said post, said post having an outer circumferential wall secured with a radial positioning plate, said gas-liquid separating filter materials having their undersides respectively provided with a recess at mutually corresponding locations for facilitating said gas-liquid separating filter materials to be piled and engaged with each other, said gas-liquid separating filter materials thus formed with a multi-ply structure, said gas-liquid separating filter materials respectively bored with a plurality of through holes, said through holes of every two adjacent gas-liquid separating filter materials staggered in arrangement, the number of said through holes of said gas-liquid separating filter materials gradually reduced layer by layer from the lowermost layer to the uppermost layer, said exhaust end of said connecting pipe communicating with said insert hole of said post.
